(19) United States
(12) Patent Application Publication
(10) Pub. No.: US 2021/0394372 A1
(43) Pub. Date: Dec. 23, 2021

(54) EQUIPMENT, NOTABLY FOR MACHINING

(71) Applicant: LE CRENEAU INDUSTRIEL, Annecy Le Vieux (FR)

(72) Inventors: Bruno BOTTON, Hauteville Sur Fier (FR); Benjamin FRARIER, Villaz (FR)

(73) Assignee: LE CRENEAU INDUSTRIEL, Annecy Le Vieux (FR)

(21) Appl. No.: 17/304,255

(22) Filed: Jun. 17, 2021

(30) Foreign Application Priority Data
Jun. 17, 2020 (FR) 20 06304

(51) Int. Cl. B25J 15/04; B25J 19/00; B25J 9/16; B25J 11/00

(52) U.S. Cl. CPC B25J 15/04; B25J 11/0055; B25J 9/1638; B25J 19/0029

(57) ABSTRACT

An equipment, notably for machining, including a machine having at least one arm, and including at least one first effector which is configured to be coupled to a free end of the arm. The equipment is modular and includes a main interface which is configured to be carried by the free end of the arm and which is configured to be coupled to the first effector, at least one secondary interface which is configured to be coupled to the main interface, and at least one second effector which is configured to be coupled to the at least one secondary interface and to the main interface. The equipment further includes at least one power supply system which is configured to supply power to the at least one secondary interface.

The present invention relates to equipment designed to carry out operations, automated tasks, notably for machining, on at least one part.

The machining may be milling, drilling, multi-drilling, or any other method for removing material. The machining may advantageously be precision machining on parts of complex shape which are, for example, at least partially concave, convex or conical, or which have multiple materials or even different thicknesses.

Different applications are conceivable, notably of mechanical construction.

In particular, in the aeronautical field one application may be the machining of acoustic panels for aircraft nacelles in order to produce noise reduction devices, such as Helmholtz resonators, enabling the noise of turbo-jet engines housed in the nacelles to be reduced.

Nacelles have a generally tubular shape or more specifically have sections with a conical or frustoconical shape.

Acoustic panels are generally made of carbon composite, aluminum, titanium, Inconel. Said acoustic panels have a multitude of holes of small diameter which are distributed so as to achieve the effect of acoustic absorption of the noises generated by the turbo-jet engines. In order to produce Helmholtz resonators with an effective impact on acoustic absorption, the distribution of the holes in the acoustic panel is very important and has a significant influence on the level of noise generated by the turbo-jet engine.

However, such an acoustic panel is able to be perforated only after having been previously shaped. As a result, the acoustic panel generally has a surface of conical, frustoconical, concave, convex or complex shape (with concave areas and convex areas). In order to achieve an effective, optimized acoustic absorption, it is necessary for the accurate positioning of the holes produced to be maintained within quite strict limits, even on such complex shapes.

Generally the equipment, notably for machining, comprises a machine enabling at least one operation, such as a machining operation, to be carried out by means of a corresponding effector. The effector is also called the aggregate in the particular field of wood machining.

A machine, including a machine tool, is understood to mean a Cartesian machine, as well as an articulated, poly-articulated, industrial robot. A Cartesian machine uses a system of Cartesian coordinates and generally moves with linear movements, whilst an articulated, poly-articulated, robot uses a system of polar coordinates and has at least one arm which is capable of pivoting about an axis of articulation.

The machine or the robot comprises at least one arm and an interface at the end of this arm, an effector or tool carrier being able to be directly coupled thereto, for example for a machining operation.

The operation or method, notably for machining, may be exacting, i.e. demanding in terms of precision and/or access to the part and/or movement of the machine or the robot.

The machines, in particular the machine tools, are often bulky and inflexible during use. More specifically, a machine tool is generally designed and dedicated for a single application and thus is not able to be easily reused for a different application. Similarly, industrial robots are generally designed for a single application.

However, in some cases the expense represented by this specific application does not make the machine, the robot, cost-effective. Once the machine, the robot, is in position it is important to be able to carry out a maximum number of operations.

Moreover, the machines (robots) are supplied with electrical power by a power supply system comprising a bundle of cables passing through a supply conduit which connects a supply panel or a control cabinet to the machine, in particular to the end of an arm of a robot.

For a given method, the fittings or supply conduit comprising the internal bundle of power supply cables may be optimized, i.e. dimensioned specifically for supplying the machine (the robot) with power for the dedicated operation. These fittings may be more or less bulky according to the power requirements of the relevant method.

However, for an exacting method, notably for machining, for which a robot has to move with precision, for example, bulky and heavy fittings may limit the movement of the robot within the range of action thereof and the flexibility of the positions in order to reach the part, for example, to be machined.

Moreover, the fittings or supply conduit impose stresses on the arm of the robot (of the machine) which may impair the accuracy of following the trajectory as well as the positioning accuracy.

The object of the invention is to remedy the aforementioned drawbacks in order to guarantee a spatial trajectory with a high level of precision and stability. A further object of the invention is to increase the flexibility of use of such machines (robots) and thus their profitability.

To this end, the subject of the invention is equipment, notably for machining, comprising a machine having at least one arm, and comprising at least one first effector which is configured to be coupled to a free end of the arm. According to the invention, the equipment is modular. It comprises:
a. a main interface which is configured to be carried by the free end of the arm and which is configured to be coupled to the first effector,
b. at least one secondary interface which is configured to be coupled to the main interface, and
c. at least one second effector which is configured to be coupled to said at least one secondary interface and to the main interface.

Moreover, the equipment comprises at least one power supply system which is configured to supply power to said at least one secondary interface.

Thus the proposed solution enables possible operations to be combined by using the same machine (or robot) whilst adjusting the power requirements.

The modularity obtained due to one or more secondary interfaces which are interposed between the main interface and an effector enables the machine to be adapted according to the operations to be carried out as a function of the required range of action, and the required power, whilst limiting the stresses/forces exerted on the arm, and also enables the new requirements to be able to be met.

More specifically, such a solution makes it possible notably to work directly with the main interface, for example for a first operation, a first method or process, requiring a lower supply of power (relative to others) for which the power supply system (in particular the conduit and the internal bundle) may be optimized, whilst at the same time fulfilling the requirements for movement, access to the part and precision.

For additional operations or methods, for example, which may be higher consumers in terms of the power requirement but which may potentially require less precision or less movement of the robot, a secondary interface may be assembled on the primary interface and carry a corresponding additional effector.

The equipment may also comprise one or more of the following features described below, taken separately or in combination.

The main interface is mounted fixedly on the free end of the arm.

The main interface is configured to provide a function of referencing secondary interfaces and/or effectors, in addition to a function of locking the effectors.

The main interface may comprise electrical and/or mechanical connectors to the various effectors.

According to a first principle of use, the equipment does not always have to resort to the use of an additional secondary interface and the main interface may be directly coupled to the first effector.

The main interface is configured to be assembled directly with the first effector when an operation associated with the first effector has to be carried out. This is advantageous, in particular, when the operation associated with the first effector is exacting in terms of precision and/or access to the part and/or movement of the machine.

The main interface is also configured to be assembled with a secondary interface which is coupled to a second, third, etc., effector when a further operation associated with this effector has to be carried out.

The secondary interface is designed to be arranged between an associated effector and the main interface.

The equipment may comprise as many secondary interfaces as required.

A secondary interface may be associated with one or more effectors which enables the flexibility of use to be further increased.

According to a second principle of use, a secondary interface is used for all of the operations. A secondary interface is thus interposed between the main interface and a corresponding effector for all of the operations.

In this case the first effector is configured to be additionally coupled to a secondary interface, the secondary interface being arranged between the first effector and the main interface.

When the equipment comprises at least two secondary interfaces, the equipment comprises an associated power supply system for each secondary interface.

The secondary interfaces have a similar assembly structure which is configured to cooperate with the main interface.

According to a further feature, the equipment comprises a referencing or positioning mechanism comprising complementary elements carried, on the one hand, by the main interface and, on the other hand, by said effectors.

The mechanism for referencing may comprise pins designed to be housed in complementary housings.

The referencing of the secondary interfaces on the main interface is advantageously carried out by complementarity of shape.

The secondary interfaces comprise an assembly structure of generally annular or cylindrical shape designed to surround the main interface.

This assembly structure, which is for example annular or cylindrical, advantageously comprises a bore which is configured to cooperate with a shoulder in the region of the main interface. This enables the secondary interface to be centered and held in position with the main interface before assembly and a locking of the corresponding effector.

Moreover, the assembly structure of the secondary interfaces may comprise electrical and/or mechanical connectors to the effectors.

The equipment further comprises a locking mechanism comprising complementary elements which are carried, on the one hand, by the main interface and, on the other hand, by said effectors.

When the secondary interface is used it is held between the main interface and the corresponding effector after being locked.

Preferably, the locking mechanism is automated.

Alternatively, the locking mechanism may be manual.

The locking mechanism comprises, for example, a locating pin designed to cooperate with a clamping module, notably comprising balls. The clamping module may be pneumatic.

According to an alternative, the locking mechanism may be magnetic and/or comprise a system of the toggle clamp or tie rod type or any other appropriate locking means.

According to a further feature, the equipment comprises a main power supply system which is configured to supply power to the main interface and at least one secondary power supply system for supplying power to said at least one secondary interface.

The main power supply system enables the functions of the main interface to be supplied with power. Notably the main power supply system enables the supply of power, for example pneumatic power, to the locking function of the main interface when it is automated.

According to the first principle of use which enables notably a so-called exacting operation by directly coupling the first effector to the main interface, the main power supply system also enables the input of power required for carrying out the operation associated with the first effector.

The main power supply system may comprise or may be implemented by an internal bundle of power cables arranged inside the arm of the robot.

Alternatively, the main power supply system may comprise one or more external elements which are added-on relative to the robot, such as added-on fittings.

The secondary power supply system enables the supply of power to the secondary interface, in order to carry out the operation associated with the associated effector.

According to one option, the main power supply system may also supply power to said at least one secondary interface, for example pneumatic power.

According to a further feature, the power supply system may comprise a fixed support carrying a supply panel.

A power supply system may comprise a supply conduit of at least one associated, main or secondary, interface which is configured to connect electrically and/or mechanically the supply panel to the associated interface.

The supply conduit comprises at least one internal bundle of cables.

The supply conduit may be arranged outside the arm of the robot. This may also apply to the power supply system(s) associated with a secondary interface. This may also be the case for the main power supply system when the functions of the main interface are not supplied by an internal power cable bundle arranged inside the arm of the robot.

The fixed support may be separate from the machine.

In particular, the main power supply system may comprise a first fixed support carrying a first supply panel and a first supply conduit which is configured to connect electrically and/or mechanically the first supply panel to the main interface. The first fixed support is implemented, for example, in the form of a post.

Similarly, the or each secondary power supply system comprises a second fixed support carrying a second supply panel and a second supply conduit configured to connect electrically and/or mechanically the second supply panel to said at least one secondary interface.

The fixed support of a power supply system of an associated secondary interface may comprise a support arm having a holding and/or compensating mechanism for the supply conduit.

The compensating mechanism may comprise at least one pretensioner.

The support arm comprises a branching carrying the holding and/or compensating mechanism.

The equipment may comprise a control unit for the arm.

The control unit may be configured to control the displacement of the arm so as to move the main interface to an assembly station with the first effector or a secondary interface, depending on the operation to be carried out. Thus the positioning of the first effector or the secondary interface and a corresponding second effector may be carried out in an automatic manner.

Alternatively, the assembly of the main interface to the first effector or to a secondary interface as well as a corresponding second effector may be carried out manually.

As a variant or in addition, the control unit comprises at least one processing means which is configured to:

a. determine a variation in load between at least two operational assemblies which are designed to be coupled to the main interface and which are associated with different operations, each operational assembly comprising at least one effector, and to

b. apply a corrective measure for compensating for the variation in load as a function of the operational assembly coupled to the main interface, depending on the operation to be carried out.

A first operational assembly may comprise the first effector which is designed to be coupled to the main interface without an intermediate secondary interface. Alternatively, a first operational assembly may comprise a first effector and a secondary interface.

The additional operational assemblies respectively comprise a set comprising a secondary interface and a second effector.

A secondary interface may be common to different operational assemblies.

Further advantages and features of the invention will become more apparent by reading the following description, which is given by way of illustrative and non-limiting example, and the accompanying drawings, in which:

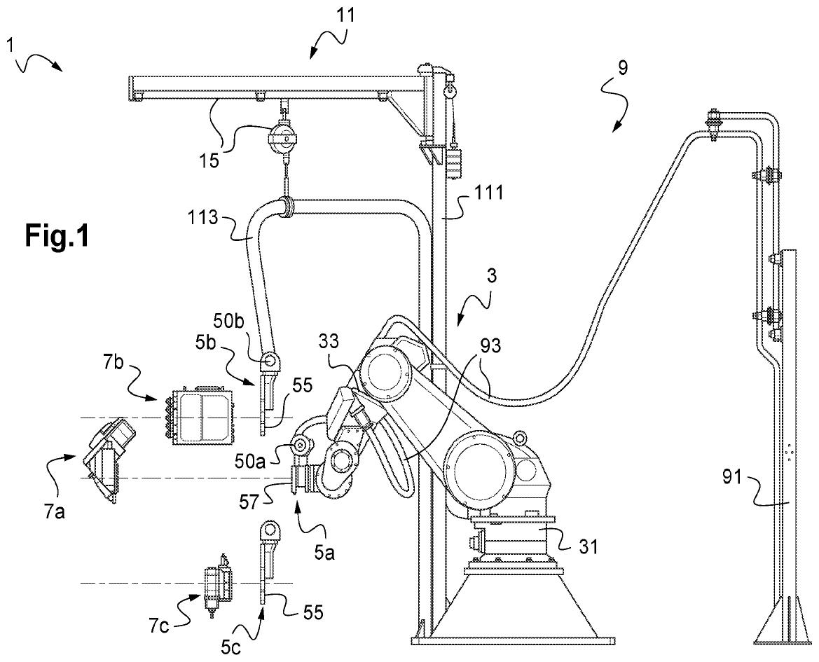

FIG. 1 is a first overall view of modular equipment for machining.

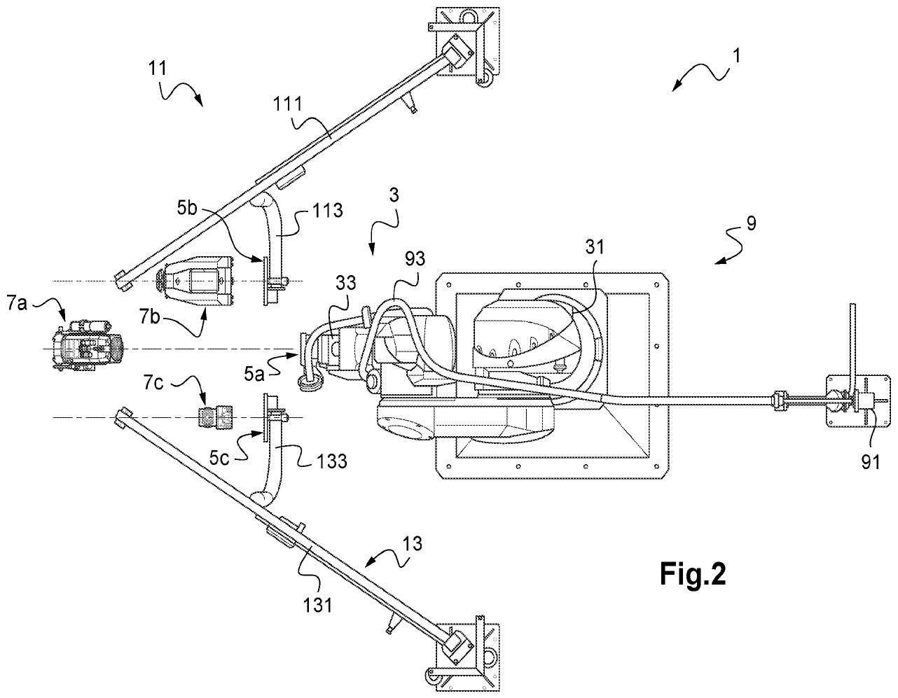

FIG. 2 is a view from above of the modular equipment of FIG. 1.

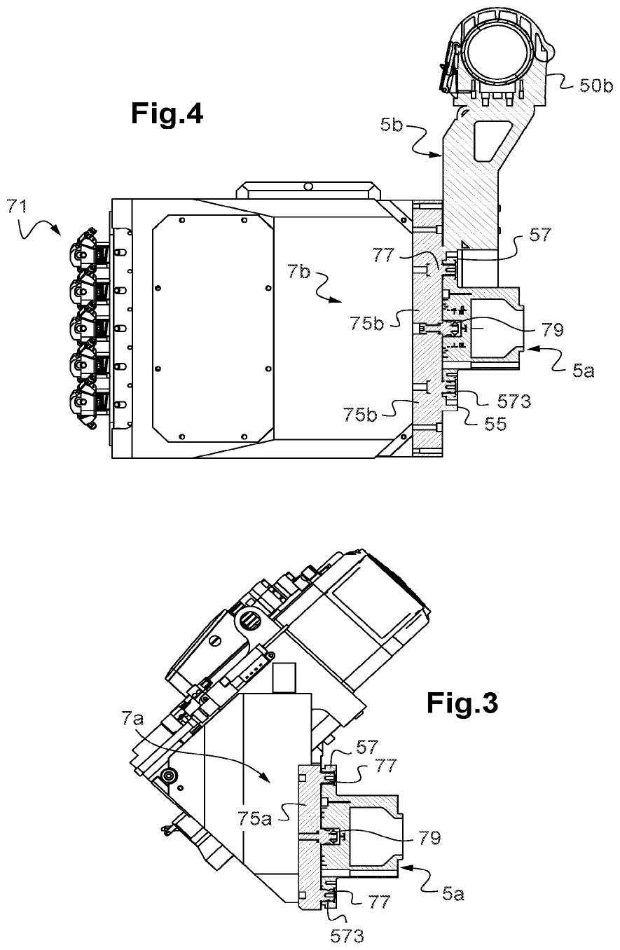

FIG. 3 is a profile view of a first effector coupled to a main interface for a robot of the equipment of FIGS. 1 and 2.

FIG. 4 is a profile view of a second effector coupled to the main interface and a secondary interface.

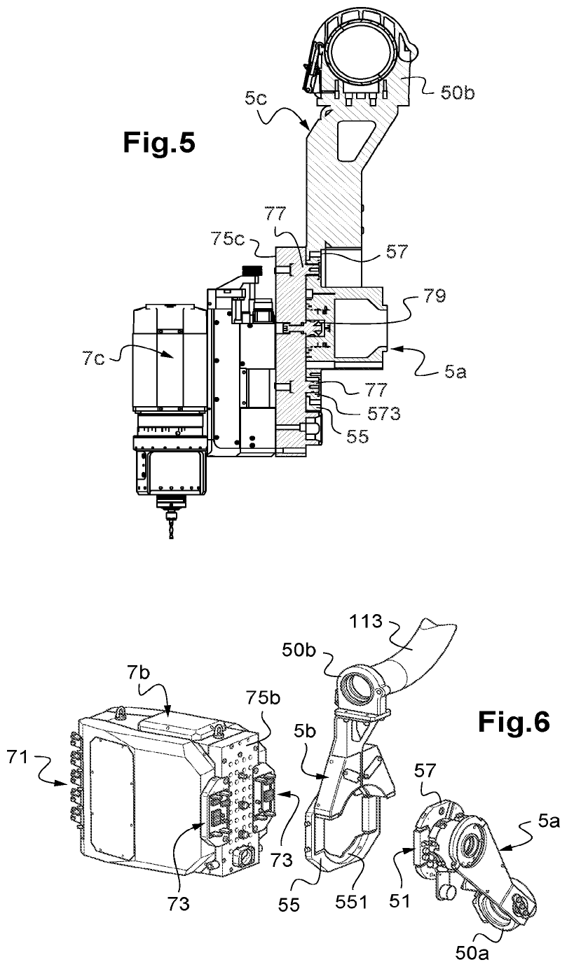

FIG. 5 is a profile view of a third effector coupled to the main interface and a further secondary interface.

FIG. 6 is a first exploded view of the main interface and of the secondary interface and of the second effector of FIG. 4.

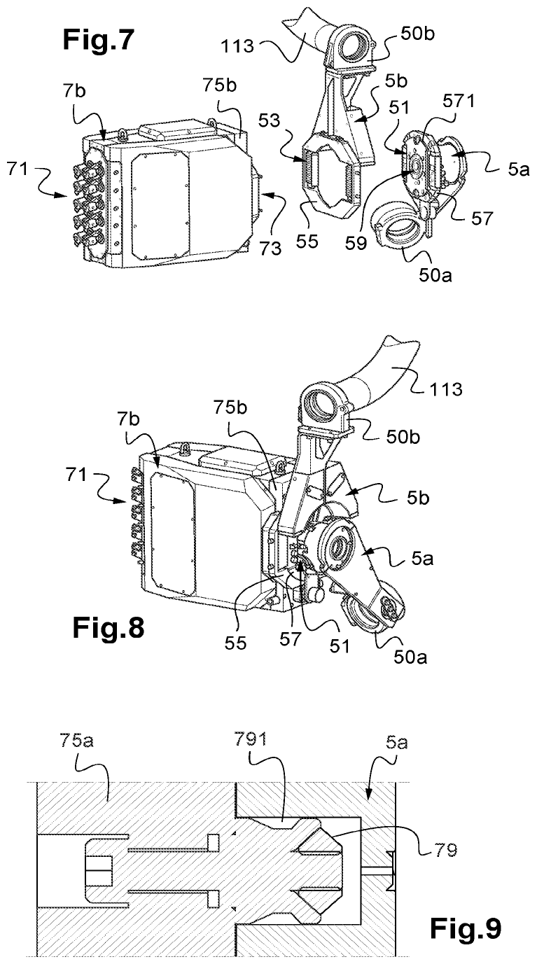

FIG. 7 is a second exploded view of the main interface and of the secondary interface and of the second effector of FIG. 4.

FIG. 8 is a perspective view of the assembled state of the main interface and of the secondary interface and of the second effector of FIGS. 6 and 7.

FIG. 9 is an enlarged view showing a detail of a locking mechanism between the main interface and the effectors of FIGS. 3 to 5.

In these figures, elements which are identical bear the same reference numerals.

The following embodiments are examples. Whilst the description refers to one or more embodiments, this does not necessarily mean that each reference relates to the same embodiment or that the features apply only to a single embodiment. Single features of different embodiments may also be combined or interchanged to provide further embodiments.

In the description it is possible to index certain elements, such as for example first, second element. This may be a simple indexing in order to differentiate and denote elements which are similar but not identical. This indexation does not necessarily imply a priority of one element relative to another and it is possible to interchange such denominations easily without departing from the scope of the present description. This indexation does not necessarily imply a chronological order.

With reference to FIGS. 1 and 2, the invention relates to equipment 1, notably for machining. The invention may relate to precision machining, for example in a non-limiting manner to machining acoustic panels for producing Helmholtz resonators.

This equipment 1 is modular. As described below, it is possible to carry out different operations or methods, notably for machining, on one or more parts. For example in a non-limiting manner, the equipment 1 may carry out operations of milling, drilling, multi-drilling and notably multi-drilling with a different number of spindles or electric spindles for drilling.

Generally, the modular equipment 1 comprises at least two modular effector units or two modular operational assemblies, including a first and at least a second thereof, which are respectively configured to be assembled to the main interface at the end of the arm.

In order to achieve this, the equipment 1 comprises:
a. a machine 3 carrying at least one main or primary interface 5a,
b. at least one secondary interface 5b, 5c,
c. effectors 7a, 7b, 7c,
d. at least one power supply system 9, 11, 13.

The effector units or modular operational assemblies respectively comprise an associated effector 7a, 7b, 7c and possibly a secondary interface 5b, 5c.

In the present case, the term “machine” refers both to a robot as illustrated in the example of FIGS. 1 and 2 and to a machine tool, a Cartesian machine.

The remainder of the description refers to a robot 3, in particular an industrial robot. This robot is articulated, poly-articulated. In particular, the robot 3 comprises a body 31, at least one articulated, poly-articulated, arm 33 extending therefrom.

The various operations or methods which the equipment 1 is able to carry out may require different movements of the robot 3 and different power requirements. For example, a first operation (such as a milling operation) may be more exacting in terms of the movement or amplitude of the robot 3 and require less power, whilst one or more possible secondary operations (such as drilling or multi-drilling operations) may require only little variation in the position of the robot 3 but may need an additional supply of power.

Alternatively, the robot 3 may be capable of carrying out different operations with a specific input of power for one or more operations but without necessarily providing a configuration which is suitable for a so-called more exacting operation as disclosed above. These configurations with or without a so-called exacting operation will be described in more detail hereinafter.

The main interface 5a is configured to be carried by the free end of the arm 33 of the robot 3. The main interface may be fixedly mounted on the free end of the arm 33. The main interface 5a may thus be permanently on the robot 3.

The main interface 5a may be coupled to an effector, for example 7a, or according to requirements to an operational assembly comprising a secondary interface 5b, 5c and a corresponding effector 7b, 7c.

The equipment 1 may comprise as many secondary interfaces 5b, 5c as required according to the number of operations or processes which are able to be combined on the robot 3.

Each secondary interface 5b, 5c is appropriate for the requirements of a method or an operation and may be coupled to at least one effector 7b, 7c in order to carry out the associated operation. The same secondary interface 5b or 5c may be associated with a plurality of effectors 7b, 7c to carry out different operations.

In the illustrated example, the equipment 1 comprises two secondary interfaces 5b, 5c. A single secondary interface or more than two secondary interfaces may be provided.

Similarly, the equipment 1 may comprise as many effectors 7a, 7b, 7c as required, according to the number of methods or operations which may be combined on the robot 3.

The secondary interfaces 5b, 5c may be put in position on the main interface 5a manually (by an operator) or conversely automatically. Similarly, the effectors 7a, 7b or 7c may be put in position manually or automatically. The secondary interfaces 5b, 5c and/or the effectors 7a, 7b, 7c may be arranged on corresponding supports (not shown) and the robot 3 may pick up the required secondary interface 5b, 5c and/or the effector 7a, 7b, 7c.

When assembled on the main interface 5a with or without the intermediate secondary interface 5b, 5c, an effector 7a, 7b, 7c forms the terminal element of the arm 33 of the robot 3 enabling the associated operation to be carried out. In the illustrated example, three effectors 7a, 7b, 7c are provided.

Different examples of effector units or operational assemblies coupled to the main interface 5a are illustrated in FIGS. 3 to 5. The operational assemblies comprise either just one effector or a set comprising a secondary interface 5b, 5c and an additional effector 7b, 7c.

Generally, according to a first principle of use, the equipment 1 is not able to resort systematically to a secondary interface, notably for a first operation associated with a first effector 7a which may be exacting, for example, in terms of the precision of the movement of the robot 3 or even the access to the part. The first effector 7a is, for example, in a non-limiting manner a milling spindle for a milling operation requiring little power but requiring a significant movement/amplitude of the robot 3.

According to this first principle, the main interface 5a may be coupled to the first effector 7a directly, i.e. without an intermediate secondary interface, as shown in FIG. 3. In this case, the effector unit comprises only the first effector 7a and not the secondary interface.

A secondary interface 7b, 7c is used between the main interface 5a and the additional effectors 7b, 7c as shown in FIGS. 4 and 5 for additional operations which may be less exacting than the first, for example requiring only little variation in the position of the robot. However, the additional operations may require more power than the first so-called exacting operation. This may be the case notably for drilling or multi-drilling.

One or more additional effectors 7b, 7c may be associated with each secondary interface 5b, 5c.

In the example of FIG. 4, the main interface 5a may be assembled to a secondary interface 5b coupled to a second effector 7b. In addition, in the example of FIG. 5, the main interface 5a may be assembled to a secondary interface 5c coupled to a third effector 7c.

According to a second principle of use, a secondary interface may be used systematically for all of the operations, both the first operation associated with the first effector 7a and for the operations associated with the additional effectors 7b, 7c. In this case, the main interface 5a is coupled each time to an operational assembly or an effector unit, i.e. a set comprising a secondary interface and an effector, in a manner similar to the examples of FIGS. 4 and 5.

Moreover, according to one or other of these principles of use, a secondary interface 5b, respectively 5c, may be paired with and correspond to only a single effector 7b, respectively 7c, as may be the case in the example of FIGS. 4 and 5.

Alternatively, the same secondary interface may correspond to different effectors. Thus such a secondary interface may be common to different operational assemblies.

More specifically, it is possible to conceive of a plurality of operations which may be similar, for example multi-drilling, associated with the same secondary interface. The effectors for multi-drilling are differentiated by the number of spindles or electric spindles 71 which they have at the end thereof, as visible in FIG. 4.

By way of non-limiting example, the equipment may use two effectors, each having a different number of spindles, for example by way of purely illustrative example an effector may have four spindles 71 and another effector may have fifteen spindles 71. In this case, the same secondary interface may be configured to be assembled on these two effectors and to be capable of supplying power to, and using, both an effector with four spindles and an effector with fifteen spindles.

Moreover, with reference to FIGS. 6 to 8, one or more complementary connectors 51, 53, 73 which are electrical and/or mechanical (pneumatic, hydraulic, fluidic or the like) are provided between the effectors and the secondary interfaces and, according to one embodiment, also the main interface 5a.

An example of the connectors 73 in the region of a secondary effector 7b is more clearly visible in FIG. 6. In addition, an example of the connectors 51 in the region of the main interface 5a is visible in FIGS. 6 and 8, and an example of the connectors 53 in the region of a secondary interface 5b is visible in FIG. 7.

As described above, when the main interface 5a is directly coupled to the first effector 7a, notably for the most exacting operation of the different operations which may be carried out by the equipment, the main interface 5a comprises such connectors 51. Conversely, according to the variant systematically using a secondary interface coupled to an effector and the main interface 5a, this main interface could be designed without such connectors.

Moreover, with further reference to FIGS. 4 and 5, the main interface 5a provides a function of referencing the secondary interfaces 5a, 5c, i.e. the secondary interface 5b, 5c may be positioned and centered relative to the main interface 5a.

The referencing of the secondary interfaces 5b, 5c on the main interface 5a is advantageously provided by complementarity of shape.

This referencing may be carried out, for example, by surface bearing.

In particular, the main interface 5a may have positioning elements designed to cooperate with complementary positioning elements provided on the secondary interfaces 5b, 5c so as to hold a given secondary interface 5b, 5c on the main interface 5a during an operation for installing an effector. This makes it possible to prevent the secondary interface 5b, 5c from moving or dropping during the installation of the effector.

The precision of the positioning of the secondary interface 5b, 5c on the main interface 5a has to meet the connection tolerances of the connectors 51, 53.

The secondary interfaces 5b, 5c have a similar assembly structure 55 forming a common hub, enabling the positioning thereof on the main interface 5a. This assembly structure 55 contains identical positioning elements on all of the secondary interfaces 5b, 5c.

The assembly structure 55 of the secondary interfaces 5b, 5c is designed to cooperate with the main interface 5a, in particular with a complementary assembly structure 57. To this end, the assembly structure 55 has a general shape which is complementary to that of the main interface 5a, in particular of its assembly structure 57.

The assembly structure 55 of the secondary interfaces 5b, 5c may be designed to surround or frame at least partially the main interface 5a. In a non-limiting manner, the assembly structure 55 of the secondary interfaces 5b, 5c may be of generally annular or cylindrical shape and designed to surround the main interface 5a, more specifically surround the assembly structure 57 thereof. The assembly structure 57 of the main interface 5a has, for example, a generally circular contour.

As a variant or additionally, the main interface 5a may form at least partially a support for the secondary interfaces, more particularly of the assembly structure 55 of the secondary interfaces 5b, 5c.

An example described hereinafter is illustrated in FIGS. 6 to 8, relating to an effector unit comprising the second secondary interface 5b and the second effector 7b and assembled on the main interface 5a. The description which follows of the assembly structure 55 of the second interface 5b with reference to these figures also applies to the third interface 5c of FIG. 5, or any other additional secondary interface, not shown.

The assembly structure 55 of the secondary interface 5b, which is for example annular, advantageously comprises a bore 551 (see FIG. 6) which is configured to cooperate with a shoulder 571 (see FIG. 7) in the region of the main interface 5a. This enables the secondary interface 5b to be referenced, centered and held in position with the main interface before the assembly and locking of the corresponding effector 7b (FIG. 8).

This example of cooperation between a shoulder 571 and a bore 551 is not limiting. An alternative which is not shown could be a cooperation of pins and bores, for example.

Moreover, the assembly structure 55 of the secondary interfaces 5b may comprise electrical and/or mechanical connectors 53 to the corresponding effectors 7b.

Similarly, notably when the main interface 5a is designed to be coupled to a first effector 7a without an intermediate secondary interface (FIG. 3), the assembly structure 57 of this main interface may carry the electrical and/or mechanical connectors to this first effector 7a.

Moreover, with reference once again to FIGS. 3 to 5, the main interface 5a also provides a function of referencing and locking the effectors 7a, 7b, 7c, i.e. an effector 7a, 7b, 7c may be positioned and centered relative to the main interface 5a and the assembly may be locked.

To this end, the equipment comprises at least one referencing and/or locking mechanism comprising complementary elements which are carried, on the one hand, by the main interface 5a and, on the other hand, by the effectors 7a, 7b, 7c.

Generally, the referencing and/or locking mechanism between the effectors 7a, 7b, 7c and the main interface 5a has to provide a precision and, in particular, enable a repeatability of the positioning of the effectors 7a, 7b, 7c on the main interface 5a. The referencing and/or locking mechanism may also be advantageously configured to enable an absorption of the forces, for example the machining forces, and of the weight, the load, of the effectors 7a, 7b, 7c. The configuration and dimensioning of such a mechanism may be carried out on the basis of the most exacting operation.

The main interface 5a thus has referencing and/or locking elements designed to cooperate with complementary elements provided on the first effector 7a and the secondary effector(s) 7b, 7c.

The effectors 7a, 7b, 7c may respectively have an end part or end face 75a, 75b, 75c having a common structure or common hub for referencing and locking to the main interface 5a.

The common structure may, for example but not necessarily, correspond to the end part 75a of the first effector 7a which is designed to be coupled to the main interface 5a without the intermediate secondary interface as in the example of FIG. 3.

According to a particular non-limiting example, a predefined number of pins 77 which are designed to be housed in complementary housings 573 may be provided for the referencing. In the example of FIGS. 3 to 5, the pins 77 are carried by the common structure of the end parts 75a, 75b, 75c of the effectors 7a, 7b, 7c and the complementary housings 573 are provided on the main interface 5a, in particular on the assembly structure of the main interface 5a. The reverse is conceivable. Such a system of pins 77 and complementary housings 573 may be on the periphery, for example. The insertion of the pins 77 in the complementary housings 573 provides the positioning and the centering of a given effector 7a, 7b, 7c relative to the main interface 5a.

One or more anti-rotation pins may be provided as a variant or in addition to such centering pins 77.

Moreover, the locking mechanism may be automated. Alternatively, the locking mechanism may be manual.

According to the illustrated embodiment, the locking mechanism comprises a locating pin 79 which is designed to cooperate with a clamping module, in particular having balls or a ball cage system 59 in the region of the main interface 5a partially visible in FIG. 7. By way of example, the locating pin 79 has a reduced cross-sectional area defining a groove 791 (most clearly visible in FIG. 9) in which the tightly spaced balls (not shown in this figure) may be housed. The system of the locating pin and balls 79 may be, for example, the central system. The clamping/releasing module is pneumatic, for example.

According to an alternative, not shown, or in addition, the locking mechanism may be magnetic and/or comprise a toggle clamp (notably in the case of manual positioning) or tie rod system or any other appropriate locking means.

After the positioning of a secondary interface 5b, 5c on the main interface 5a, the secondary interface 5b, 5c is sandwiched at least partially between the main interface 5a and the corresponding effector 7a, 7b, 7c as illustrated in FIGS. 4, 5 and 8. In other words, the secondary interface 5b, 5c is definitively positioned and locked when the effector 7a, 7b, 7c is coupled to the main interface 5a (i.e. it is positioned and locked).

With further reference to FIGS. 1 and 2, the interfaces 5a and/or 5b and 5c are designed to be supplied with electrical and/or mechanical power.

Advantageously, a main power supply system 9 is provided to supply power to the main interface 5a. This may be minimal when the locking mechanism between the main interface 5a and the effectors 7a, 7b, 7c is automated. For example, the main power supply system 9 enables the locking function of the main interface 5a to be supplied with pneumatic power.

The main power supply system 9 is also required for the embodiment in which the main interface 5a may be directly coupled to the first effector 7a. The main interface 5a also ensures the function of supplying power for the operation associated with the first effector 7a, which is advantageously the most exacting as mentioned above. In this case, the main power supply system 9 is advantageously optimized specifically for the operation associated with the first effector 7a.

According to one option, the main power supply system 9 may comprise one or more external elements which are added-on relative to the robot 3. One example is described hereinafter with reference to the embodiment of FIGS. 1 and 2 with added-on fittings, which are external relative to the robot 3.

According to a further option (not shown) the main power supply system may comprise a bundle of power cables inside the arm 33, i.e. located in the interior of the arm 33 of the robot 3, or use such an internal bundle already provided in the arm 33 of the robot 3. This option is advantageous, in particular in the minimal configuration described above, enabling power to be supplied only for a locking function of the main interface 5a, or alternatively when the power requirements are low when the main interface 5a is coupled to the first effector 7a. In other words, power is supplied to the functions of the main interface 5a by the internal bundle of the robot 3. Thus the main power supply system produced by this internal bundle does not comprise an added-on element which is external relative to the robot 3. This optimizes the robot 3 even further, notably when it has to fulfill an exacting operation associated with the first effector 7a.

According to the embodiment illustrated in FIGS. 1 and 2, the main power supply system 9 comprises a fixed support 91 and a first supply conduit 93.

The first fixed support 91 carries, for example, a first supply panel. The first fixed support is separate from the robot 3, for example it is produced in the form of a post.

The first supply conduit 93 (also called the main fittings) comprises at least one internal bundle of cables. The power required for the operation associated with the first effector 7a, for example the most exacting operation, may be routed via the main fittings or the first supply conduit 93. This supply conduit may be optimized, i.e. in particular dimensioned in an optimized manner, and advantageously reduced when this so-called exacting operation, for example milling, notably in terms of the movement of the robot 3, does not require many power supply cables.

The first supply conduit 93, or more specifically the internal cable bundle thereof, makes it possible to connect electrically and/or mechanically the first supply panel to the main interface 5a. To this end the main interface 5a has a connecting portion 50a, which is for example annular, to the first supply conduit 93. This connecting portion 50a forms, for example, an end of the main interface 5a opposite the end having the structure 57 which is designed to cooperate with a secondary interface 5b, 5c and/or an effector 7a, 7b, 7c. A connecting arm may be provided between this structure 57 and the connecting portion 50a.

Moreover, since the main interface 5a is positioned on the arm of the robot 3, the supply conduit 93 routing power to this main interface 5a at the end of the arm of the robot 3 does not exert any stress on the robot 3 and permits a maximum amplitude of the arm 33 with a minimum tension or stress applied by this first supply conduit 93. Thus the situation is avoided that deviations or inaccuracies are generated at the end of the arm 33 of the robot 3.

Each secondary interface 5b or 5c is designed to be connected to a power supply system 11, 13 specific to the associated operation, so as to enable the supply of power for additional operations which are different from the first operation and which may, for example, require more power and more cables than the first operation. In this case, the electrical distribution systems 11, 13 are called secondary systems.

According to the alternative in which a secondary interface is systematically used for all of the operations, in this case the main interface 5a may have only one function of referencing and locking, and not a function of supplying power, this function being provided by the secondary interfaces and a specific distribution system 11, 13 enabling the supply of power required for each operation.

According to one option, the main power supply system may also supply the secondary interfaces with the power which is already available for the main interface, and which may be combined, for example, in a non-limiting manner with pneumatic power, notably when the locking function in the region of the main interface 5a is provided by a pneumatic mechanism.

Thus according to one or other of the principles of use (with or without systematically using a secondary interface) each secondary interface 5b or 5c is designed to be connected to a range of different types of power specific to the operation(s) associated with the corresponding effectors 7b, 7c. To achieve this, a power supply system 11, 13 is associated with each secondary interface 5b, 5c.

In the example of FIGS. 1 and 2, one power supply system 11 is associated with the second secondary interface 5b and a different power supply system 13 is associated with the third secondary interface 5c. When a so-called main first power supply system is provided as described above, in this case the so-called secondary power supply system(s) associated with a secondary interface 5b, respectively 5c, are called the second power supply system 11, respectively the third power supply system 13.

The second power supply system 11 comprises a second fixed support 111 and a second supply conduit 113. Similarly, the third power supply system 13 comprises a third fixed support 131 and a third supply conduit 133. The terms “second” and “third” apply in the example in which a main power supply system 9 is provided and comprises a first fixed support and a first supply conduit. Naturally, the fixed support 111, respectively 131, and the supply conduit 113, respectively 133, of a power supply system 11, respectively 13, associated with a secondary interface 5b, respectively 5c, are not dependent on the presence of a first fixed support and a first supply conduit.

Similar to the example of the main power supply system 9 described above, the second, respectively third, fixed support 111, respectively 131, may carry a second, respectively third, supply panel. These fixed support(s) 111, 131 are separate from the robot 3. The additional fixed support(s) 111, 131 may be arranged to the side relative to the body 31 of the machine at a predefined distance.

Advantageously the second and/or the third fixed support 111, 131 comprises or is produced in the form of a support arm. This support arm may carry a holding and/or compensating mechanism 15 for the corresponding supply conduit 113, 133. This holding and/or compensating mechanism 15 may comprise, for example, a pretensioner. In particular, the support arm comprises a branching carrying such a pretensioner.

It could be conceived as an alternative that the second and third fixed supports 131, 133 are produced in the form of a post.

As described above for the first supply conduit 93, the supply conduits 113, 133 (or fittings) respectively support at least one internal bundle of cables making it possible to supply the required power for the specific operations respectively associated with the effectors 7b, 7c to which the secondary interfaces 5b, 5c are respectively coupled.

The supply conduits 113, 133, more specifically their respective internal bundles of cables, make it possible to connect electrically and/or mechanically the corresponding supply panel to the associated secondary interface 5b, respectively 5c. To this end, the secondary interfaces 5b, 5c have a connecting portion 50b, respectively 50c, which is for example annular, to the corresponding supply conduit 113, 133. This connecting portion 50b, 50c forms, for example, an end of the secondary interface 5b, 5c opposing the end having the assembly structure 55 which is designed to cooperate with the main interface 5a. A connecting arm may be provided between this assembly structure 55 and the connecting portion 50b, respectively 50c.

Such supply conduits 93, 113, 133 (or fittings) may be more or less bulky and heavy according to the needs of the associated operations. The locking mechanisms enabling the effectors 7a, 7b, 7c to be held on the main interface 5a with or without a secondary intermediate interface 5b, 5c are advantageously dimensioned so as to withstand the forces inherent in such conduits.

Finally the equipment 1 comprises a control unit for the arm 33 of the robot 3.

This control unit is notably able to control the displacement of the arm 33 for a gripping operation of a secondary interface 5b, 5c or an effector 7a, 7b, 7c to be loaded on the robot 3. In this case, the control unit is able to control the displacement of the arm 33 in order to move the main interface 5a in the region of an assembly station with the first effector 7a on a corresponding support (not shown) or with a secondary interface 5b, 5c on a different corresponding support, according to the operation to be carried out. Thus as described above, the positioning of the first effector 7a or a secondary interface 5b, 5c and then of a corresponding effector 7b, 7c may be carried out automatically.

The control unit advantageously makes it possible to control the power which is sent to a secondary interface 5b, 5c, in particular when the secondary interface may be associated with different effectors. For example, as described above, in the case of a common secondary interface for multi-drilling effectors having a variable number of spindles, the control unit makes it possible to send just the power required to the spindles, according to the effector which is assembled on the secondary interface.

Finally, a compensation may be implemented in terms of control in order to manage the variations in load in the region of the main interface 5a. More specifically, two effectors may be very different in terms of dimension and load for two given operations. This load may have an impact on the robot 3 and the accuracy of the spatial positioning of the robot 3 and by way of a purely illustrative example in the case of a difference in load of 80 kg, depending on the effector or the operational assembly which is coupled to the main interface 5a, the robot 3 risks being badly positioned and being inaccurate.

To achieve this, the control unit may comprise at least one processing means which is configured to determine a variation in load between at least two operational assemblies designed to be coupled to the main interface 5a and associated with different operations. The control unit receives the inertias specific to each assembly which is designed to be mounted on the main interface 5a.

This processing means or a further processing means may be configured to apply a corrective measure for compensating for the variation in load as a function of the operational assembly which is effectively coupled to the main interface 5a. This permits a compensation of the effect of the load on the stiffness of the articulated joints and on the laws of automatic control and also contributes further to avoiding inaccuracies of the robot 3.

The above description refers to a robot 3, in particular an industrial robot. Naturally this description may also apply to a machine tool, a conventional Cartesian machine, notably if it is lightweight, since it may have a similar problem of restrictions within the range of action or inaccuracies which are associated with the fittings exerting a stress and risking a deviation of the trajectory of its arm.

Thus the secondary interface(s) 5b, 5c which are associated with the effectors and which may be loaded on the main interface 5a at the end of the arm of the robot 3, more generally of the machine, enable the operations, processes, to be combined in a simple manner on the same robot or machine, said operations potentially having variable power requirements and requiring a high level of precision or a wide range of action of the robot 3, the machine, whilst limiting the stresses exerted on the arm 33 thereof.

It is no longer necessary to provide a plurality of machines for the different operations, which makes it possible to optimize the cost of production of parts and the profitability of the machine.

Moreover, this permits greater precision on the part. More specifically, by being able to carry out several operations on one part which is arranged in a single tool on a single machining means, it is possible to overcome the variations associated with the successive repositioning of the part in the different tools and the localizations of the tool assembly and part in each machine carrying out the operation.

The main interface 5a may potentially be supplied with power using a main supply conduit 93 which may or may not be inside the arm 33 of the robot 3, whilst the secondary interfaces 5b, 5c are supplied with power by additional supply conduits 113, 133 supported by specific supports 111, 131 separately from the robot 3, more generally from the machine. This makes it possible to carry out the cabling (routing, connection to the secondary interfaces 5b, 5c, connection to the control panel) without requiring the physical presence of the robot 3, of the machine.

Moreover, this solution provides an opportunity for the continuous development of the machine 3 by adding the necessary secondary interfaces in order to respond to new requirements, new markets.

This solution also makes it possible to reduce the time required for manufacturing, or installing, the machine and also to reduce the risks of malfunction when restarting.

1. An equipment comprising a machine having at least one arm, and comprising at least one first effector configured to be coupled to a free end of the arm, wherein:
the equipment is modular and comprises:
a main interface configured to be carried by the free end of the arm and configured to be coupled to the first effector,
at least one secondary interface configured to be coupled to the main interface, and
at least one second effector configured to be coupled to said at least one secondary interface and to the main interface, and wherein
the equipment comprises at least one power supply system configured to supply power to said at least one secondary interface.

2. The equipment according to claim 1, wherein the first effector is configured to be additionally coupled to a secondary interface, the secondary interface being arranged between the first effector and the main interface.

3. The equipment according to claim 1, comprising:
at least two secondary interfaces and
an associated power supply system for each secondary interface.

4. The equipment according to claim 3, wherein the secondary interfaces have a similar assembly structure configured to cooperate with the main interface.

5. The equipment according to claim 1, comprising a locking mechanism comprising complementary elements carried by the main interface and by said effectors.

6. The equipment according to claim 1, comprising:
a main power supply system configured to supply power to the main interface and
at least one secondary power supply system for supplying power to said at least one secondary interface.

7. The equipment according to claim 1, wherein said power supply system comprises a fixed support carrying a supply panel and a supply conduit of an associated interface configured to connect electrically and/or mechanically the supply panel to the associated interface.

8. The equipment according to claim 7, wherein the fixed support of a power supply system of an associated secondary interface comprises a support arm having a holding and/or compensating mechanism for the supply conduit.

9. The equipment according to claim 1, comprising a control unit for the arm which is configured to control the displacement of the arm so as to move the main interface to an assembly station with the first effector or a secondary interface, depending on the operation to be carried out.

10. The equipment according to claim 9, wherein the control unit comprises at least one processing means which is configured to:
determine a variation in load between at least two operational assemblies which are designed to be coupled to the main interface and which are associated with different operations, each operational assembly comprising at least one effector, and to
apply a corrective measure for compensating for a variation in load as a function of the operational assembly coupled to the main interface, depending on the operation to be carried out.
